(19) United States
(12) Patent Application Publication
(10) Pub. No.: US 2009/0303860 A1
(43) Pub. Date: Dec. 10, 2009

(54) Recording Process Status Deciding Apparatus and Recording Process Status Deciding Method

(75) Inventors: Akira Takahashi, Saitama (JP); Yasuyuki Umehara, Saitama (JP); Takashi Hora, Saitama (JP)

Correspondence Address: KRATZ, QUINTOS & HANSON, LLP, 1420 K Street, N.W., Suite 400, WASHINGTON, DC, 20005, US

(73) Assignee: Pioneer Corporation, Tokyo (JP)

(21) Appl. No.: 11/921,162

(22) PCT Filed: May 29, 2006
(86) PCT No.: PCT/JP2006/310633

§ 371 Date: Aug. 26, 2009

(30) Foreign Application Priority Data
May 31, 2005 (JP) 2005-160202

(51) Int. Cl. G11B 7/0037

(52) U.S. Cl. 369/124.14; G9B/7.005

(57) ABSTRACT

A disk-layer-configuration judging unit (180) of a recording-and-reproducing apparatus (100) judges which of a one-layer disk (10) and a two-layer disk (20) is a disk in which content data is to be recorded. A system controller (280) sets a recording rate to be a conventional recording rate when the disk-layer-configuration judging unit (180) judges that the disk is the one-layer disk (10) while setting the recording rate to be a recording rate that makes the maximum recordable time twice as much as the maximum recordable time of the one-layer disk (10) when the disk-layer-configuration judging unit (180) judges that the disk is the two-layer disk (20).

### TECHNICAL FIELD

The present invention relates to a recording-processing-state determining device and a recording-processing-state determining method for setting a recording-processing state when content data is recorded.

### BACKGROUND ART

There has been conventionally known a configuration that records a variety of data in a recording medium. According to one example of such a configuration, a recording rate is changed based on a data amount recordable in a recording medium (for instance, see Patent Document 1).

The configuration according to Patent Document 1 computes or acquires a storage capacity of an optical disk in which data is to be recorded. Then, according to the configuration, a recording signal is recorded at a recording rate that is obtained by dividing the storage capacity by time required for recording (i.e., time that is obtained by subtracting a starting time from an ending time, the starting and ending time being recorded in a memory thereof).

[Patent Document 1] JP-A-11-213556 (page 4 right column to page 8 right column)

### DISCLOSURE OF THE INVENTION

### Problems to be Solved by the Invention

However, since the recording rate is set in accordance with the storage capacity in such a configuration as is described in Patent Document 1, image data may be recorded in one recording medium with different image quality against a user's intension. Thus, a problem in such a configuration is that a user may not be able to view a video at constant image quality.

In addition, there has been conventionally known a recording device that records data in a recording medium having at least one recording layer in which a variety of data is recordable. However, since a logic configuration of recorded data (configuration of a data configuration region) and a physical configuration of a disk itself (track pitch and the like) are different between a recording medium having a plurality of recording layers and a recording medium having one recording layer, the maximum time for recording at a predetermined recording mode (maximum recordable time) may not be substantially proportional to the number of the recording layers. Accordingly, a recording-processing state may be set, for instance, by a user based on a premise that the maximum recordable time of the recording medium having two recording layers is approximately twice as much as the maximum recordable time of the recording medium having one recording layer (hereinafter, referred to as one-layer recording medium), such that the entirety of a content whose broadcasting time is approximately twice as much as the maximum recordable time of the one-layer recording medium may not be recorded in the recording medium.

In light of the above-described problems, an object of the present invention is to provide a recording-processing state determining device and a recording-process state determining method that can suitably determine a recording-processing state when data is recorded.

### Means for Solving the Problems

A recording-processing-state determining device according to one aspect of the present invention is a recording-processing-state determining device that determines a recording-processing state when predetermined data is recorded, the device including: a recording-layer-configuration judging unit that judges the number of plural recording layers provided in a recording medium, the recording layers being adapted to record the data; and a state determining unit that determines the recording-processing state such that a data amount recordable in the recording medium is related to the number of the recording layers judged by the recording-layer-configuration judging unit by that of a recording medium whose number of the recording layers is one.

A recording-processing-state determining method according to another aspect of the present invention is a method for determining a recording-processing state by an arithmetic unit when recording predetermined data, the method including the steps of: judging the number of plural recording layers provided in a recording medium by the arithmetic unit, the recording layers being adapted to record the data; and determining the recording-processing state by the arithmetic unit such that a data amount recordable in the recording medium is related to the judged number of the recording layers by that of a recording medium whose number of the recording layers is one.

### BRIEF DESCRIPTION OF DRAWINGS

FIG. 1 is an illustration schematically showing a structure of a one-layer disk that experiences a recording and reproducing processing in a recording-and-reproducing apparatus according to an embodiment of the present invention.

FIG. 2 is an illustration schematically showing a structure of a two-layer disk that experiences a recording and reproducing processing in the recording-and-reproducing apparatus according to the embodiment of the present invention.

FIG. 3 is a block diagram showing a schematic arrangement of the recording-and-reproducing apparatus according to the embodiment.

FIG. 4 is a flow chart showing a recording processing of content data according to the embodiment.

FIG. 5 is a flow chart showing a recording processing of content data according to another embodiment of the present invention.

### EXPLANATION OF CODES

10: DVD serving as a recording medium (one-layer disk)
11, 21, 22: Recording layer
20: DVD serving as a recording medium (two-layer disk)
180: disk-layer-configuration judging unit serving as a recording-layer-configuration judging unit that is included in a recording-processing-state determining device and an arithmetic unit
280: system controller that may be used as a state determining unit that is included in a recording-processing-state determining device and an arithmetic unit

### BEST MODE FOR CARRYING OUT THE INVENTION

An embodiment of the present invention will be described below with reference to the attached drawings. Although a recording-and-reproducing apparatus that includes a recording-processing device having a recording-process-state determining device according to the present invention is exemplarily described in the present embodiment, the present invention is not limited thereto but may be applicable to any arrangements that determine a recording-process-state when data is recorded.

### [Configuration of One-Layer Disk]

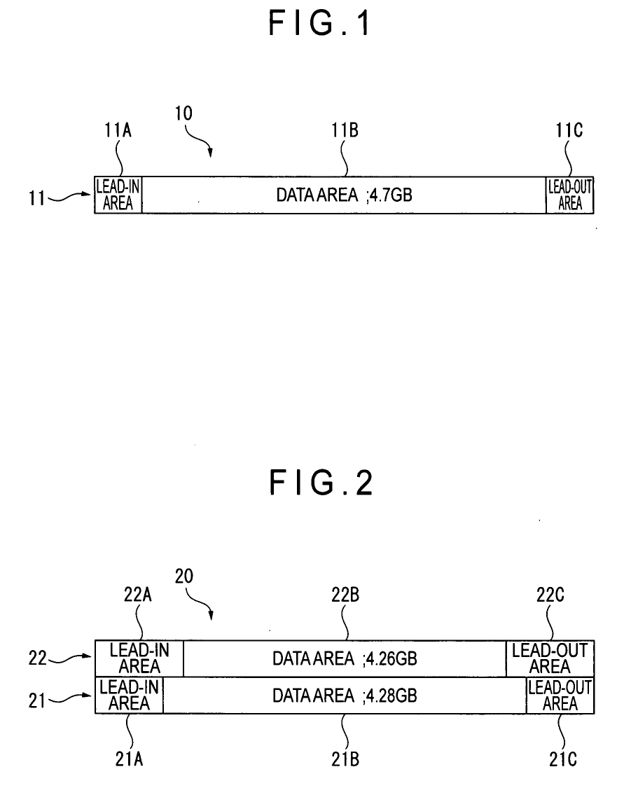

With reference to FIG. 1, a configuration of a DVD (Digital Versatile Disk) with a one-layered recording layer (hereinafter referred to as one-layer disk) will be described. The one-layer disk, which serves as a recording medium having a one-layered recording layer, experiences a recording and reproducing processing in a recording-and-reproducing apparatus according to an embodiment of the present invention. FIG. 1 is an illustration schematically showing a configuration of the one-layer disk that experiences a recording and reproducing processing in the recording-and-reproducing apparatus.

In FIG. 1, the numeral 10 denotes a one-layer disk. The one-layer disk 10 is shaped in a circular disk in which a substantially circular center hole (not shown) is formed substantially at the center thereof. A first side of the one-layer disk 10 provides a recording layer 11. The recording layer 11 includes a lead-in area 11A whose most inner periphery side records a lead-in code for indicating a starting end. The lead-in area 11A further records a variety of information about the one-layer disk 10. In the recording layer 11, a data area 11B is provided adjacently to the lead-in area 11A at an outer periphery side of the lead-in area 11A. The data area 11B can record a variety of data such as content data up to a capacity of approximately 4.7 GB. In the recording layer 11, a lead-out area 11C, in which a lead-out code for indicating a terminal end of the data area 11B, is provided adjacently to the data area 11B at an outer periphery side of the data area 11B.

### [Configuration of Two-Layer Disk]

Next, with reference to FIG. 2, a configuration of a DVD with a two-layered recording layer (hereinafter referred to as two-layer disk) will be described. The two-layer disk, which serves as a recording medium having a two-layered recording layer, experiences a recording and reproducing processing in the recording-and-reproducing apparatus. FIG. 2 is an illustration schematically showing a configuration of the two-layer disk that experiences a recording and reproducing processing in the recording-and-reproducing apparatus.

In FIG. 2, the numeral 20 denotes a two-layer disk. The two-layer disk 20 is shaped in a circular disk. A first side of the two-layer disk 20 provides a first recording layer 21. The first recording layer 21 includes: a lead-in area 21A that records a variety of information about the two-layer disk 20; a data area 21B that can record a variety of data up to a capacity of approximately 4.28 GB; and a lead-out area 21C. A second recording layer 22 is laminated on the first recording layer 21 to be bonded thereto by, for example, an adhesive. The second recording layer 22 includes a lead-in area 22A, a data area 22B that can record a variety of data up to a capacity of approximately 4.26 GB, and a lead-out area 21C. A storage capacity of the two-layer disk 20 is approximately 8.54 GB, which is less than a double of a storage capacity of the one-layer disk 10. Particularly, the storage capacity of the two-layer disk 20 is approximately 90 percent of that of the one-layer disk 10. The above-described storage capacity inconsistency between the two-layer disk and the one-layer disk is exemplarily attributed to reasons that: a bonding accuracy of the recording layers 21, 22 is not secured; the second recording layer 22 cannot record data unless the first recording layer 21 records data; and a physical configuration of a disk itself (such as a track pitch) is different between the one-layer and two-layer disks.

### [Arrangement of Recording-and-Reproducing Apparatus]

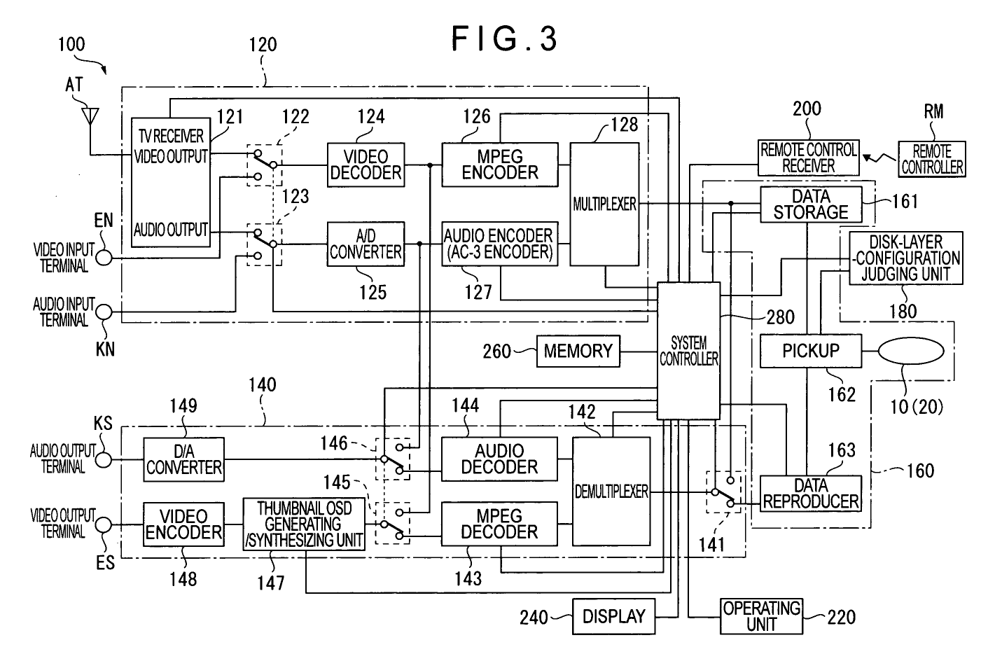

Next, a schematic arrangement of the recording-and-reproducing apparatus will be described below with reference to FIG. 3. FIG. 3 is a block diagram schematically showing an arrangement of the recording-and-reproducing apparatus.

In FIG. 3, the numeral 100 denotes the recording-and-reproducing apparatus. The recording-and-reproducing apparatus 100 records and reproduces content data as necessary. The content data may be content data of a TV program or a movie that has been received via, for example, a TV antenna, or that has been reproduced in another reproducing apparatus. The recording-and-reproducing apparatus 100 includes a data input unit 120 (data acquiring unit), a data output unit 140, recording-and-reproducing processor 160, a disk-layer-configuration judging unit 180 (recording-layer-configuration judging unit), a remote control receiver 200, an operating unit 220, a display 240, a memory 260, and a system controller 280 that may be used as a state determining unit. The disk-layer-configuration judging unit 180 and the system controller 280 are included in a recording-processing-state determining device and an arithmetic unit according to the present invention.

The data input unit 120 acquires content data from outside and outputs as necessary the acquired content data to the data output unit 140 and the recording-and-reproducing processor 160. The data input unit 120 includes a TV (television) receiver 121, a first input switch 122, a second input switch 123, a video decoder 124, an A/D converter 125, an MPEG (Moving Picture Coding Experts Group) encoder 126, an audio encoder 127 and multiplexer 128.

The TV receiver 121 is connected with an antenna AT for receiving airwaves from broadcasters, the system controller 280 and the like. The TV receiver 121 is connected as necessary to the video decoder 124 via the first input switch 122. In addition, the TV receiver 121 is connected as necessary to the A/D converter 125 via the second input switch 123. The TV receiver 121 acquires a content data signal such as VHF (Very High Frequency) or BS (Broadcasting Satellite) received by and output from the antenna AT. Then, the TV receiver 121 demodulates a signal within a receiving band selected by a user into an analog video signal to output as necessary the demodulated signal to the video decoder 124 via the first input switch 122. In addition, the TV receiver 121 demodulates the acquired signal into an analog audio signal to output as necessary the demodulated signal to the A/D converter 125 via the second input switch 123.

The first input switch 122 is connected to the video decoder 124 and the like. The first input switch 122 is controlled by the system controller 280 to connect as necessary a video input terminal EN to the video decoder 124 or the TV receiver 121 to the video decoder 124. An AV data output equipment (not shown) that outputs a video signal of video data etc. of the content data is detachably connected to the video input terminal EN.

The second input switch 123 is connected to A/D converter 125, the system controller 280 and the like. The second input switch 123 is controlled by the system controller 280 to connect as necessary an audio input terminal KN to the A/D converter 125 or the TV receiver 121 to the A/D converter 125. An AV data output equipment that outputs an audio signal of audio data etc. of the content data is detachably connected to the audio input terminal KN. When the first input switch 122, for example, connects the TV receiver 121 to the video decoder 124, the second input switch 123 connects the TV receiver 121 to the A/D converter 125.

The video decoder 124 is connected to the MPEG encoder 126. The video decoder 124 is further connected to a later-described thumbnail OSD (On Screen Display) generating-and-synthesizing unit 147 via a later-described second output switch 145. The video decoder 124 acquires as necessary a video signal from the TV receiver 121 or from the video input terminal EN. Then, the video decoder 124 converts as necessary the acquired signal into a digital video signal to output as necessary the converted signal to the MPEG encoder 126 or the thumbnail OSD generating-and-synthesizing unit 147.

The A/D converter 125 is connected to the audio encoder 127. The A/D converter 125 is further connected to a later-described D/A converter 149 via a later-described third output switch 146. The A/D converter 125 acquires as necessary an audio signal from the TV receiver 121 or from the audio input terminal KN. Then, the A/D converter 125 converts as necessary the acquired signal into a digital audio signal to output as necessary the converted signal to the audio encoder 127 or the D/A converter 149.

The MPEG encoder 126 is connected to the multiplexer 128, the system controller 280 and the like. The MPEG encoder 126 acquires the video signal from video decoder 124. Then, the MPEG encoder 126 converts the acquired video signal into an MPEG-format video data to output the converted data to the multiplexer 128. In addition, the MPEG encoder 126 acquires recording rate information from the system controller 280. The recording rate information demands that the content data be recorded at a predetermined recording rate (compression rate).

The audio encoder 127 is connected to the multiplexer 128, the system controller 280 and the like. The audio encoder 127 acquires the audio signal from the A/D converter 125. Then, the audio encoder 127 converts the acquired audio signal into audio data of an AC-3 (Audio Code Number 3) format to output the converted data to the multiplexer 128.

The multiplexer 128 is connected to a later-described data storage 161 of the recording-and-reproducing processor 160, the system controller 280 and the like. The multiplexer 128 is further connected to a later-described demultiplexer 142 via a later-described first output switch 141. The multiplexer 128 acquires as necessary the video data from the MPEG encoder 126 and the audio data from the audio encoder 127. Then, the multiplexer 128 generates, for example, a program stream of the content data based on the video data and the audio data to output the generated program stream to the data storage 161 or to the demultiplexer 142.

The data output unit 140 acquires as necessary the content data from the data input unit 120 and from the recording-and-reproducing processor 160 to output as necessary the acquired content data to the outside. The data output unit 140 includes the first output switch 141, the demultiplexer 142, an MPEG decoder 143, an audio decoder 144, the second output switch 145, the third output switch 146, the thumbnail OSD generating-and-synthesizing unit 147, a video encoder 148 and the D/A converter 149.

The first output switch 141 is connected to the demultiplexer 142, a later-described data reproducer 163 of the recording-and-reproducing processor 160, the system controller 280 and the like. The first output switch 141 is controlled by the system controller 280 to connect as necessary the multiplexer 128 to the demultiplexer 142 or the data reproducer 163 to the demultiplexer 142.

The demultiplexer 142 is connected to the MPEG decoder 143, the audio decoder 144, the system controller 280 and the like. The demultiplexer 142 acquires as necessary the program stream of the content data from the multiplexer 128 and the data reproducer 163 to demultiplex the program stream into the MPEG-format video data and the AC-3 format audio data. Then, the demultiplexer 142 outputs as necessary the video data to the MPEG decoder 143 and the audio data to the audio decoder 144.

The MPEG decoder 143 is connected to the system controller 280 and the like. The MPEG decoder 143 is further connected as necessary to the thumbnail OSD generating-and-synthesizing unit 147 via the second output switch 145. The MPEG decoder 143 acquires as necessary the video data from the demultiplexer 142 and converts as necessary the acquired data into a digital video signal after decoding the acquired data. Then, the MPEG decoder 143 outputs as necessary the converted video signal to the thumbnail OSD generating-and-synthesizing unit 147 via the second output switch 145.

The audio decoder 144 is connected to the system controller 280 and the like. The audio decoder 144 is further connected as necessary to the D/A converter 149 via the third output switch 146. The audio decoder 144 acquires as necessary the audio data from the demultiplexer 142 and converts as necessary the acquired data into a digital audio signal after decoding the acquired data. Then, the audio decoder 144 outputs as necessary the converted audio signal to the D/A converter 149 via the third output switch 146.

The second output switch 145 is connected to the thumbnail OSD generating-and-synthesizing unit 147 and the like. The second output switch 145 is controlled by the system controller 280 to connect as necessary the video decoder 124 to the thumbnail OSD generating-and-synthesizing unit 147 or the MPEG decoder 143 to the thumbnail OSD generating-and-synthesizing unit 147.

The third output switch 146 is connected to the D/A converter 149, the system controller 280 and the like. The third output switch 146 is controlled by the system controller 280 to connect as necessary the A/D converter 125 to the D/A converter 149 or the audio decoder 144 to the D/A converter 149. When the first output switch 146, for example, connects the MPEG decoder 143 to the thumbnail OSD generating-and-synthesizing unit 147, the third output switch 146 connects the audio decoder 144 to the D/A converter 149.

The thumbnail OSD generating-and-synthesizing unit 147 is connected to the video encoder 148, the system controller 280 and the like. The thumbnail OSD generating-and-synthesizing unit 147 is controlled by the system controller 280 to generate as necessary, what is called, thumbnail images of the contents recorded in, for example, the one-layer disk 10 or the two-layer disk 20. Then, the thumbnail OSD generating-and-synthesizing unit 147 converts as necessary the generated thumbnail images into thumbnail image signals so that the thumbnail images are displayed in a display (not shown), and outputs the converted signal to the video encoder 148. In addition, the thumbnail OSD generating-and-synthesizing unit 147 acquires the video signal from the video decoder 124 and the MPEG decoder 143 to generate as necessary synthesized video for displaying video in which predetermined literal information is superposed on the video of the video signal. Then, the thumbnail OSD generating-and-synthesizing unit 147 converts as necessary the synthesized video into a synthesized video signal to output the converted signal to the video encoder 148. In addition, the thumbnail OSD generating-and-synthesizing unit 147 acquires the video signal from the video decoder 124 and the MPEG decoder 143, and output the acquired signal to the video encoder 148 without performing any processing on the acquired signal.

The video encoder 148 is connected to a video output terminal ES to which, for example, a display is detachably connected. The video encoder 148 acquires as necessary the video signal, the synthesized video signal and the thumbnail image signals from the thumbnail OSD generating-and-synthesizing unit 147. Then, the video encoder 148 converts as necessary the video signal, the synthesized video signal and the thumbnail image signals into analog signals, and outputs the converted signals to the video output terminal ES.

The D/A converter 149 is connected to an audio output terminal KS to which, for example, the display is detachably connected. The D/A converter 149 acquires the audio signal from the A/D converter 125 and the audio decoder 144. Then, the D/A converter 149 converts as necessary the audio signal into an analog signal to output the converted signal to the audio output terminal KS.

The recording-and-reproducing processor 160 exemplarily acquires the content data from the data input unit 120 to record the acquired data in the one-layer disk 10 or the two-layer disk 20, and reproduces the content data recorded in the one-layer disk 10 or the two-layer disk 20 to output the data to the data output unit 140. The recording-and-reproducing processor 160 includes the data storage 161, a pickup 162 and the data reproducer 163. The data input unit 120, the data storage 161, the pickup 162, the disk-layer-configuration judging unit 180 and the system controller 280 are included in the recording-processing device according to the present invention.

The data storage 161 is connected to the pickup 162, the system controller 280 and the like. The data storage 161 controls the pickup 162 to record as necessary the content data from the multiplexer 128 in the recording layer 11 of the one-layer disk 10 or the recording layers 21, 22 of the two-layer disk 20 at the recording rate of the recording rate information.

The pickup 162 is connected to the data reproducer 163, the disk-layer-configuration judging unit 180 and the like. When recognizing that the one-layer disk 10 or the two-layer disk 20 is mounted on a disk mounting portion (not shown), the pickup 162 irradiates laser light to the mounted one-layer disk 10 or the mounted two-layer disk 20 in a predetermined state. Then, the pickup 162 receives the laser light reflected from the one-layer disk 10 or the two-layer disk 20, and outputs to the disk-layer-configuration judging unit 180 a light-receiving state signal corresponding to the light-receiving state at the time of receiving the reflected light. The pickup 162 is controlled by the data storage 161 to record as necessary the program stream of the content data in the one-layer disk 10 or the two-layer disk 20 at the recording rate relevant to the one-layer disk 10 or the two-layer disk 20. In addition, the pickup 162 is controlled by the data reproducer 163 to read as necessary the program stream of the content data from the one-layer disk 10 or the two-layer disk 20 that has been mounted on the disk mounting portion, and output the program stream to the data reproducer 163.

The data reproducer 163 is connected to the system controller 280 and the like. Controlled by the system controller 280, the data reproducer 163 controls the pickup 162 to read the program stream of the content data that corresponds to a predetermined content, and acquires the program stream. Then, the data reproducer 163 outputs as necessary the program stream to the demultiplexer 142.

The disk-layer-configuration judging unit 180 is connected to the system controller 280 and the like. The disk-layer-configuration judging unit 180 judges as necessary a configuration of the recording layer(s) of the disk mounted on the disk mounting portion. Specifically, the disk-layer-configuration judging unit 180 acquires the light-receiving state signal from the pickup 162. Then, the disk-layer-configuration judging unit 180 recognizes that the one-layer disk 10 or the two-layer disk 20 is mounted on the disk mounting portion based on the acquired light-receiving state signal, and outputs to the system controller 280 mounted-disk identifying information that identifies a type of the mounted disk.

The remote control receiver 200 is connected to the system controller 280 and the like. The remote control receiver 200 receives an infrared ray from a remote controller RM. Then, the remote control receiver 200 acquires as necessary a setting item signal related to setting items of the recording-and-reproducing apparatus 100 contained in the infrared ray, and outputs the signal to the system controller 280.

The operating unit 220 is connected to the system controller 280 and the like. The operating unit 220 includes operation buttons, operation knobs and the like (none of which is shown). Then, the operating unit 220 generates a setting item signal related to setting items by, for example, input operations of the operation buttons, and outputs the signal to the system controller 280.

The display 240 is connected to the system controller 280 and the like. Examples of the display 240 may include a liquid crystal display, an organic EL (Electro Luminescence) panel, an FED (Field Emission Display), an electrophoretic display panel and the like. The display 240 is controlled by the system controller 280 to screen-display image data output from the system controller 280. The screen-displayed image data may be image data related to operations of the recording-and-reproducing apparatus 100, image data related to the setting items set and input by the remote controller RM and the operating unit 220 and other image data.

The memory 260 holds a variety of information or data related to recording or reproducing processing of the content data such as programming information about programmed recording processing or the mounted disk identifying information (i.e., stores the information or data in a manner that the stored information or data can be read out at any time). The memory 260 also stores a variety of programs that are used on an OS (Operating System) for operation-controlling the entire recording-and-reproducing apparatus 100. The memory 260 may be preferably a memory that can retain the stored information or data even when a power supply is suddenly suspended due to, for example, a blackout. Examples of such a memory are a SRAM, a FLASH memory and the like.

The system controller 280 sets as necessary the recording rate so that the maximum recordable time of the one-layer disk 10 or the two-layer disk 20 (hereinafter referred to as maximum recordable time) is proportional to the number of the recording layer, and controls the data storage 161 and the pickup 162 to perform recording-processing of the content data.

Specifically, as described above, the storage capacity of the two-layer disk 20 is less than the double of that of the one-layer disk 10. Accordingly, when the data-recording in the one-layer disk 10 and the two-layer disk 20 is performed at the same recording rate, the maximum recording time of the two-layer disk 20 in each recording mode of, what are called, a high image quality mode (XP mode), a standard mode (SP mode) and a long time mode (LP mode) becomes shorter than the double of that of the one-layer disk 10. It should be noted that the types and names of the recording modes may vary and that the scope of the present invention is not limited to the above-described types and names of the recording modes.

TABLE 1

| Recording Mode | One-Layer Disk | Two-Layer Disk |
|---|---|---|
| XP | app. 61 minutes | app. 115 minutes |
| SP | app. 120 minutes | app. 220 minute |
| LP | app. 240 minutes | app. 441 minutes |

Hence, in order that the maximum recording time of the two-layer disk 20 becomes approximately twice as much as the maximum recording time of the one-layer disk, the system controller 280 sets the recording rate for the one-layer disk 10 in each of the recording modes to be the same as a conventional recording rate while setting the recording rate for the two-layer disk 20 to be approximately 90 percent of the recording rate for the one-layer disk 10.

TABLE 2

| Recording Mode | One-Layer Disk | Two-Layer Disk |
|---|---|---|
| XP | app. 61 minutes | app. 122 minutes |
| SP | app. 120 minutes | app. 240 minute |
| LP | app. 240 minutes | app. 480 minutes |

More specifically, the system controller 280 acquires the mounted disk identifying information from the disk-layer-configuration judging unit 180, and controls as necessary the memory 260 to store the acquired mounted disk identifying information. Then, when recognizing that content data of a content that is currently being received is started to be recording-processed based on, for example, the input operations of the operating unit 220 or that content data of a content whose recording start time and date in the programming information coincides with the current time and date clocked by a clock (not shown) is started to be received and recording-processed, the system controller 280 recognizes, for example, which of XP mode, SP mode and LP mode is the recording mode preset by a user. In addition, the system controller 280 acquires the mounted disk identifying information from the memory 260 and recognizes which of the one-layer disk 10 and two-layer disk 20 is used as the disk for recording the content data. Then, when recognizing that the disk is the one-layer disk 10, the system controller 280 generates recording rate information demanding that the content data be recorded at the conventional recording rate, and outputs the information to the data storage 161.

On the other hand, when recognizing the disk for recording is the two-layer disk 20, the system controller computes a recording rate to make the maximum recordable time of the two-layer disk 20 approximately twice as much as that of the one-layer disk 10. As described above, the recording rate for the two-layer disk 20 is set to be approximately 90 percent of the recording rate for the one-layer disk 10. Then, the system controller 280 outputs to the data storage 161 recording rate information about the computed recording rate. In addition, the system controller 280 controls the data input unit 120 to acquire the content data to be recorded and output the acquired data to the data storage 161.

The system controller 280 controls as necessary the data input unit 120, data output unit 140, the recording-and-reproducing processor 160 and the like to perform as necessary operations such as reproducing processing of the content data.

### [Operations of Recording-and-Reproducing Apparatus]

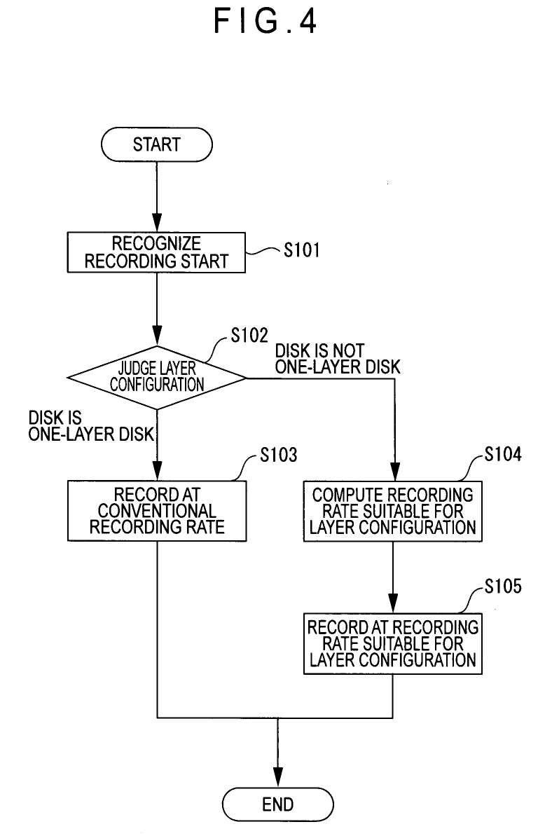

Next, recording processing of the content data, one of the operations of the recording-and-reproducing apparatus 100, will be described based on the attached drawings. FIG. 4 is a flow chart showing recording processing of the content data.

As shown in FIG. 4, the system controller 280 of the recording-and-reproducing apparatus 100 initially recognizes, based on, for example, the programming information, that the content data of the content is started to be recording-processed (step S101). Then, the system controller 280 recognizes that the disk for recording the content data is the one-layer disk 10 or the two-layer disk 20 (i.e., processing of judging the layer configuration) (step S102). In the step S102, the system controller 280, judging that the disk is the one-layer disk 10, controls the recording-and-reproducing processor 160 and the like to record the content data in the one-layer disk 10 at the conventional recording rate (step S103), and terminates the processing.

On the other hand, in the step S102, the system controller 280, judging that the disk is not one-layer disk 10 but an n-layer disk (n is a natural number equal to or more than two) (i.e., the disk is the two-layer disk 20), computes such a recording rate as to make the maximum recording time of the disk approximately twice as much as that of the one-layer disk 10, i.e., a recording rate suitable for the layer configuration (step S104). Then, the system controller 280 controls the recording-and-reproducing processor 160 and the like to record the content data in the two-layer disk 20 at the recording rate suitable for the layer configuration of the disk (step S105), and terminates the processing.

### [Effects and Advantages of Recording-and-Reproducing Apparatus]

As described above, in the above embodiment, using the disk-layer-configuration judging unit 180, the recording-and-reproducing apparatus 100 judges which of the one-layer disk 10 and the two-layer disk 20 is used as the disk for recording the content data, and outputs the mounted disk information about the judgment to the system controller 280. Then, recognizing that the disk is the one-layer disk 10 based on the mounted disk information, the system controller 280 outputs to the data storage 161 the recording rate information demanding that the content data be recorded at the conventional recording rate. In contrast, recognizing that the disk is the two-layer disk 20, the system controller 280 outputs to the data storage 161 the recording rate information demanding that the content data be recorded at the recording rate that is approximately 90 percent of the conventional recording rate. With this arrangement, even when, for example, the recording processing is set by a user based on a premise that the maximum recordable time of the two-layer disk 20 is approximately twice as much as that of the one-layer disk 10, the recording-and-reproducing apparatus 100 can record in the two-layer disk 20 the entirety of a content whose broadcast time is approximately twice as long as the maximum recordable time of the one-layer disk 10. In addition, since the recording rate is set to be in conformity with the number of the recording layer of the disk in which the content data is to be recorded, the arrangement according to the present invention is, unlike a conventional arrangement, free from a risk that the content data is recorded in one disk with different image quality contrary to a user's intension, thereby providing a user with video of constant image quality. Accordingly, the recording-and-reproducing apparatus 100 can suitably determine the recording rate of the content data, in other words, a recording-processing state when the content data is recorded.

The system controller 280 performs a setting-processing of the recording rate as a processing of setting the recording-processing state of the content data, and controls the recording-and-reproducing processor 160 to record the content data at the set recording rate. Accordingly, as compared with an arrangement in which, for example, a compression state (i.e., compression method and compression rate) of the content data is set, such that the recording-and-reproducing processor 160 is controlled to record the content data in the set compression state, the arrangement of the recording-and-reproducing processor 160 can be simplified and a processing load of the processor 160 can be reduced.

The system controller 280 sets the recording rate for the content data received from the TV receiver 121 or input by the AV data output equipment. Accordingly, the content broadcasted in the TV or output from the AV data output equipment can be suitably recorded in the one-layer disk 10 or the two-layer disk 20, thereby further improving a convenience of the recording-and-reproducing apparatus 100.

### Modifications of Embodiment

It should be noted that the present invention is not limited to the exemplary embodiments described above, but may include modifications described below within a scope where an object of the present invention can be achieved.

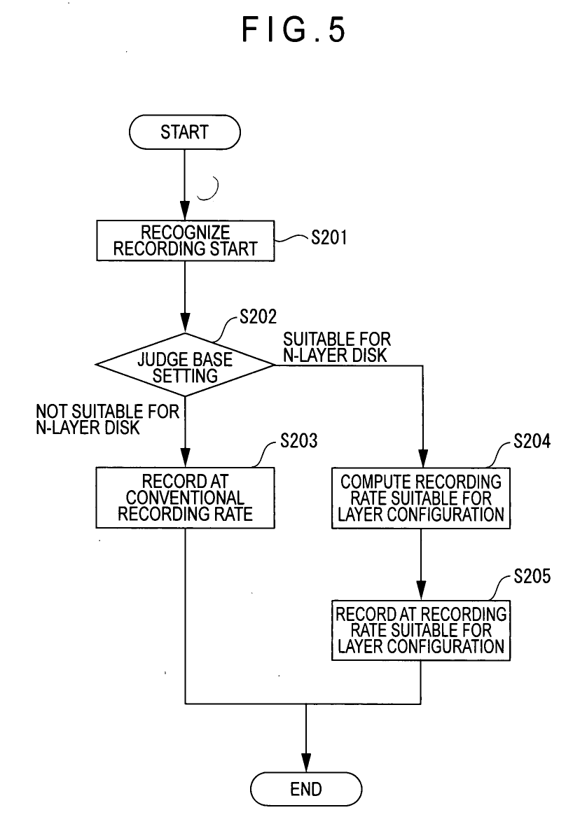

Specifically, the recording-and-reproducing apparatus 100 may be provided with an arrangement that records the content data in such a recording medium as an HD (Hard Disk) or a blue-ray disk whose storage capacity is greater than that of the two-layer disk 20, and perform, for example, processing shown in FIG. 5. Particularly, the system controller 280, recognizing that the recording-processing of the content data is started (step S201), recognizes whether or not such a setting has been made as to record the content data in a manner suitable for n-layer disk (i.e., performs judging-processing of a base setting) (step S202). In the step S202, when judging that the setting is not suitable for the n-layer disk, the system controller 280 recognizes that the data is to be recorded in a manner suitable for the one-layer disk 10 and controls the content data to be recorded in, for instance, an HD at the conventional recording rate (step S20), thereby terminating the processing. On the other hand, in the step S202, when judging that the setting is suitable for the n-layer disk (in this example, suitable for the two-layer disk 20), the system controller 280 computes a recording rate suitable for the layer configuration as in the above-described embodiments (step S204). Then, the system controller 280 controls the content data to be recorded in the HD at the recording rate suitable for the layer configuration thereof (step S205), and terminates the processing.

With this arrangement, the recording-and-reproducing apparatus 100 sets the recording rate suitable for the two-layer disk 20 to be such a recording rate as to make the maximum recordable time thereof approximately twice as much as that of the one-layer disk 10, and records the content data in the HD. Thus, without performing special processing, content data whose volume is approximately twice as much as the maximum recordable time of the one-layer disk 10 can be suitably copied to the two-layer disk 20. Accordingly, the recording-and-reproducing apparatus 100 can easily and suitably copy the content data recorded in the HD to the one-layer disk 10 or to the two-layer disk 20. In addition, a user is allowed to set as necessary the recording rate for the content data to be recorded in the HD, whereby convenience of the recording-and-reproducing apparatus 100 is improved. Such an arrangement as to perform the processing shown in FIG. 5 may be adapted in an arrangement where the contend data is recorded in the one-layer disk 10 or the two-layer disk 20 (i.e., an arrangement where no recording-and-reproducing processor 160 is provided).

Further, the system controller 280 may be arranged to set a compression state of the content data as the setting-processing of the recording-processing state of the content data. The system controller 280 may be arranged to set a resolution of the video based on the video data of the content data. The system controller 280 may be arranged to set an encode format to be MPEG, DivX or the like. With the arrangements, the recording-and-reproducing apparatus 100 can also suitably record the content data in the one-layer disk 10 or the two-layer disk 20 as in the above-described embodiments.

Although an arrangement in which a recording controller according to the present invention is applied to the recording-and-reproducing apparatus that performs recording-processing and reproducing-processing has been exemplified, the recording controller may be applied to a recording apparatus that only performs recording-processing. In addition, the disk-layer-configuration judging unit 180 and the system controller 280 may be independently provided. The disk is not limited to the two-layer disk but may be a DVD that includes a plurality of recording layers (i.e., three-layer disk, four-layer disk, etc.). The recording medium is not limited to a DVD but may be any recording medium having a plurality of recording layers such as a CD (Compact Disk), a MD (Mini Disk) or a blue-ray disk. The data may be any type of data such as audio data, music data, image data or program data of a game or an application software.

Although the above-described functions are exemplarily performed by a program, the functions are not limited thereto but may be performed by any other configuration, examples of which are a hardware such as a circuit substrate or a device such as one IC (Integrated Circuit). By arranging the above-described functions to be read out from a program or separately from a recording medium, the handling of the apparatus is facilitated, thereby facilitating broader use of the apparatus.

Specific configurations and processes when implementing the present invention may be other configurations or the like as long as an object of the present invention can be attained.

### Effects and Advantages of Embodiments

As described above, in the above embodiment, the recording-and-reproducing apparatus 100 judges which of the one-layer disk 10 and the two-layer disk 20 is used as the disk for recording the content data, and sets the recording rate to be the conventional recording rate when judging that the disk is the one-layer disk 10. On the other hand, when judging that the disk is two-layer disk 20, the recording-and-reproducing apparatus sets the recording rate to be such a recording rate as to make the maximum recordable time approximately twice as much as that of the one-layer disk 10. With this arrangement, even when, for example, the recording processing is set by a user based on a premise that the maximum recordable time of the two-layer disk 20 is approximately twice as much as that of the one-layer disk 10, the recording-and-reproducing apparatus 100 can record in the two-layer disk 20 the entirety of a content whose broadcast time is approximately twice as long as the maximum recordable time of the one-layer disk 10. In addition, since the recording rate is set to be in conformity with the number of the recording layer of the disk in which the content data is to be recorded, the arrangement according to the present invention is, unlike a conventional arrangement, free from a risk that the content data is recorded in one disk with different image quality contrary to a user's intension, thereby providing a user with video of constant image quality. Thus, the recording-and-reproducing apparatus 100 can suitably determine a recording-processing state when the content data is recorded.

### INDUSTRIAL APPLICABILITY

The present invention is applicable to a recording-processing-state determining device and a recording-processing-state determining method for setting a recording-processing state when content data is recorded.

1. A recording-processing-state determining device that determines a recording-processing state of predetermined data that is recorded in a multi-layer recording medium, comprising:
a recording-layer-configuration judging unit that judges the number of plural recording layers provided in the multi-layer recording medium, the recording layers being adapted to record the data; and
a state determining unit that determines the recording-processing state such that recordable time of the data in the multi-layer recording medium equals to recordable time obtained by multiplying time recordable in a recording medium having the one recording layer by the number of the recording layers judged by the recording-layer-configuration judging unit.

2. The recording-processing state determining device according to claim 1, wherein the recording-processing state is a recording rate when the data is recorded.

3. The recording-processing-state determining device according to claim 2, wherein the state determining unit sets the recording rate to be a ratio of an actual storage capacity of the multi-layer recording medium to a value obtained by multiplying a storage capacity of the recording medium having the one recording layer by the number of the recording layers.

4. The recording-processing-state determining device according to claim 1, wherein the state determining unit performs a processing of determining a compression state of the data when the data is recorded as a processing of determining the recording-processing state.

5. The recording-processing-state determining device according to claim 1, wherein the state determining unit performs a processing of determining an encode format of the data when the data is recorded as the processing of determining the recording-processing state.

6. A method for determining a recording-processing-state of predetermined data that is recorded in a multi-layer recording medium by an arithmetic unit, comprising the steps of:
judging the number of plural recording layers provided in the multi-layer recording medium by the arithmetic unit, the recording layers being adapted to record the data; and
determining the recording-processing state by the arithmetic unit such that recordable time in the multi-layer recording medium equals to recordable time obtained by multiplying time recordable in a recording medium having the one recording layer by the judged number of the recording layers.

7. A recording-processing-state determining device that determines a recording-processing state of predetermined data that is recorded in a recording medium whose storage capacity is larger than that of a multi-layer disk, comprising:
a setting unit that sets the recording-processing device to record the data in the recording medium in a manner suitable for the multi-layer disk;
a judging unit that judges a setting state set by the setting unit; and
a state determining unit that determines the recording-processing state such that recordable time of the data in the multi-layer disk equals to recordable time obtained by multiplying time recordable in a disk having one recording layer by the number of recording layers of the multi-layer disk, the number of the recording layers having been set by the setting unit.

8. The recording-processing state determining device according to claim 7, wherein the recording medium is a hard disk.

9. The recording-processing state determining device according to claim 7, wherein the recording-processing state is a recording rate when the data is recorded.

10. The recording-processing state determining device according to claim 9, wherein the state determining unit sets the recording rate to be a ratio of an actual storage capacity of the multi-layer disk to a value obtained by multiplying a storage capacity of the disk having the one recording layer by the number of the recording layers.

11. The recording-processing state determining device according to claim 7, wherein the state determining unit performs a processing of determining a compression state of the data when the data is recorded as a processing of determining the recording-processing state.

12. The recording-processing state determining device according to claim 7, wherein the state determining unit performs a processing of determining an encode format when the data is recorded as the processing of determining the recording-processing state.

13. The recording-processing state determining device according to claim 8, wherein the recording-processing state is a recording rate when the data is recorded.

14. The recording-processing state determining device according to claim 8, wherein the state determining unit performs a processing of determining a compression state of the data when the data is recorded as a processing of determining the recording-processing state.

15. The recording-processing state determining device according to claim 8, wherein the state determining unit performs a processing of determining an encode format when the data is recorded as the processing of determining the recording-processing state.
